(19) United States
(12) Patent Application Publication
(10) Pub. No.: US 2003/0217463 A1
(43) Pub. Date: Nov. 27, 2003

(54) Method and apparatus for manufacturing implantable electrodes having controlled surface area and integral conductors

(76) Inventors: John A. Schmidt, Durango, CO (US); Randolph S. Bock, Angleton, TX (US); Elmar R. Fischer, Lake Jackson, TX (US)

Correspondence Address: GOTTLIEB RACKMAN & REISMAN PC, 270 MADISON AVENUE, 8TH FLOOR, NEW YORK, NY, 100160601

(21) Appl. No.: 10/154,589

(22) Filed: May 24, 2002

(51) Int. Cl. H01R 43/00; B23P 19/00

(52) U.S. Cl. 29/857; 29/825; 29/745

(57) ABSTRACT

An apparatus for manufacture and method manufacturing of implantable, coiled electrodes that are integral with their associated conductor. Electrodes of differing selected sizes may be manufactured by the method described herein and mounted on a single catheter. The size of the electrodes may be selected to optimize electrode performance for sensing, stimulation or other purposes. The apparatus comprises a motor-driven winding mandrel. A tensioning device, mounted generally perpendicularly to the axis of rotation of the mandrel, controls tension in a wire being formed into a coiled electrode. A holding apparatus clamps a portion of the wire along the mandrel. In one embodiment, the holding apparatus comprises a sheath surrounding the mandrel. The mandrel fits into a hole in the sheath. By controlling the diameter of the hole with respect to the diameter of the mandrel, the radius of curvature of a bend between the coiled electrode and a straight part of the wire can be controlled. The coiled electrodes may be coated with materials such as titanium nitride, iridium oxide, or other materials to provide a fine surface structure or improved biocompatibility for the electrode.

### BACKGROUND OF INVENTION

1. Field of Invention

This invention relates to catheters or to electrodes adapted to be inserted into a body cavity. More specifically, the invention involves a method for making an electrode having a controlled surface area and an integral conductor. The invention further involves assembling such manufactured electrodes on a catheter containing a large number of such electrodes.

2. Background Art

Cardiovascular disease is the leading cause of death in the United States, Europe and Japan, claiming more lives each year than all other diseases combined. The prevalence of this disease has prompted the development of numerous methods and devices to diagnose and treat various cardiac problems. One such device that aids in the diagnosis and treatment of heart disease is the electrode catheter. In general, various types of catheters containing electrodes have been used to perform endocardial procedures for treatment and diagnosis of cardiac related problems.

Examples of these devices include the stimulation catheter of Berkovits U.S. Pat. No. 3,825,015, the flow directed catheter of Blake et. al. U.S. Pat. No. 3,995,623, the multi-contact plunge electrode of Kline U.S. Pat. No. 4,172,451, the defibrillating catheter of Schulte et al. U.S. Pat. No. 5,545,205, the implantation catheter of Obino et al. U.S. Pat. No. 5,800,498 and the pacing lead delivery catheter of Bonner U.S. Pat. No. 6,055,457.

More specifically, in the diagnosis of cardiac conditions, electrode catheters have been used to map cardiac electrical activity. This mapping procedure is useful for the detection and treatment of conduction abnormalities and heart tissue deficiencies. Some cardiac mapping procedures are described in the article entitled: “Techniques of Intraoperative Electrophysiologic Mapping” in the American Journal of Cardiology, by John J. Gallagher, et al. which appeared in Volume 49 pages 221-240 January of 1982.

During a typical mapping procedure, a cardiac map is generated by recording the electric signals from the heart and depicting them spatially as a function of time. In an endocardial procedure, an electrode catheter is inserted into a chamber of the heart to measure signals directly by contact with the inside walls of the chamber. Accordingly, the number and placement of electrodes on or within the catheter is an important design consideration for maximizing effectiveness and efficiency for this internal procedure.

Several prior art electrode catheters have been used to generate cardiac maps. Hess U.S. Pat. No. 4,573,473 teaches a catheter with four electrode contacts on a flat planar surface. Gelinas et al. U.S. Pat. No. 4,522,212 teaches a catheter with three or more separated flexible leg electrodes. Chilson U.S. Pat. No. 4,699,147 and Edwards U.S. Pat. No. 5,471,982 define catheters with flexible electrodes that form a basket when extended. Giba et al. U.S. Pat. No. 5,997,526 discloses a shape memory catheter having electrode plates or bands. Unfortunately, such prior art devices are hard to deploy and complicated to manipulate. These difficulties often result in numerous unsuccessful treatment attempts as well as time-consuming procedures.

It is known that the effectiveness of an implantable electrode is related to the surface area of the electrode. For different functions, however, the relationship between electrode size and electrode effectiveness is different. For example, stimulation thresholds (the electrical energy necessary to cause a muscular contraction in the heart) are generally lower for smaller electrodes. On the other hand, larger electrodes are usually better for sensing intrinsic electrical activity in the heart or other part of the body. Modern pacemaker leads often utilize a stimulation tip or a ring electrode for both pacing and sensing. Current lead tips are composed of solid metal, cut and shaped into a variety of geometries. In general, the surface area of the lead tip is usually approximated as a hemisphere, regardless of the actual shape of the tip. Manufacture of such electrodes can be difficult and time consuming. For example, a solid blank of metal may be machined to form a shank at one end. The opposite end may be rounded to form a hemisphere that is then bisected by a plurality of slots. The intersection of the slots may then be hollowed out. Extremely fine machining tools or electron beam machining may be necessary.

The completed electrode is usually coupled to a conductor by crimping or welding two metal components together. Because of the small size of the parts, expensive laser techniques are often employed. If the metals are different, as they often are, new alloys appear at the union. There may be reduced strength, reduced fatigue resistance, or changes in electromotive force resulting in corrosion. All of these changes are unpredictable.

Many of the problems of the art are addressed in U.S. patent application Ser. No. 09/761,333, the disclosure of which is incorporated herein by reference. In application Ser. No. 09/761,333, a catheter is described comprising a collection of wire leads disposed in a flexible tube. Each wire lead has a terminal end, an insulated portion and a non-insulated coiled electrode. The continuous coiled electrode preferably has at least one but no more than twenty-five turns. To prevent the coils from unraveling, the coils of each electrode may be knitted, glued or fused together, for example. Starting at the distal end of the tube, the coiled electrode of each wire lead protrudes from the tube at predetermined longitudinal positions and coils around the exterior of the tube. The ends of the collection of wire leads protrude from the proximal end of the tube and are coupled to a suitable connector for connection to an apparatus which may be used to map the cardiac tissues, to monitor the condition of the heart, or to apply appropriate therapy.

### BRIEF SUMMARY OF THE INVENTION

The apparatus for manufacture and method described herein provides for the manufacture of coiled sensing and stimulation electrodes that are integral with their associated conductor. The stimulation electrodes are continuous with a conductor so that no attachment mechanism, such as a weld, is necessary to connect the conductor to the electrode. A catheter with such electrodes can be inserted into a patient's heart to stimulate the heart, map cardiac electrical activity, heart wall position, heart wall motion and tissue viability for purposes of medical diagnosis and treatment of congestive heart failure, bradycardia or tachyarrhythmias, as well as other purposes. Electrodes of differing selected sizes may be manufactured by the method described herein and mounted on a single catheter. The size of the electrodes may be selected to optimize electrode performance for sensing, stimulation or other purposes.

The apparatus comprises a motor-driven winding mandrel. Reduction gears may substantially reduce the rotation speed of the mandrel. A control unit may detect the number of turns of the mandrel and can halt the apparatus at a selected number of turns. A tensioning device, mounted generally perpendicularly to the axis of rotation of the mandrel, controls tension in a wire being formed into a coiled electrode. A holding apparatus clamps a portion of the wire along the mandrel. In one embodiment, the holding apparatus comprises a sheath surrounding the mandrel and capturing the wire between the mandrel and the sheath. The mandrel fits into a hole in the sheath. By controlling the diameter of the hole with respect to the diameter of the mandrel, the radius of curvature of a bend between the coiled electrode and a straight part of the wire can be controlled.

The apparatus winds individual small coils of any selected diameter and any selected number of turns. The surface area of the electrode can be readily determined and specified. Electrodes of different sizes can be placed at selected locations along a lead or catheter, allowing the electrodes to be optimized for sensing, stimulation, or other functions. The coiled electrode portions may be coated with materials such as titanium nitride, iridium oxide, or other materials. The coating may provide a fine surface structure or improved biocompatibility for the electrode.

It is an object of the invention, therefore, to provide an apparatus and method for manufacturing implantable electrodes having controllable surface areas.

It is a further object of the invention to provide an apparatus and method for manufacturing coiled electrodes having an integral conductor.

Another object of the invention is to provide for the manufacture of coil electrodes with integral conductors having transitional bends between the electrode and the conductor or wire.

Yet another object of the invention is to control the radius of curvature of the transitional bend.

Still another object of the invention is to provide an apparatus that can plastically deform a wire into a coiled electrode having a specified number of turns. These and other objects and features of the invention will be apparent from the following detailed description, taken with respect of the accompanying drawings.

### BRIEF DESCRIPTION OF DRAWINGS

FIG. 1 shows a catheter with multiple coil electrodes implanted in a heart.

FIG. 2 shows a catheter with multiple coil electrodes.

FIG. 3 shows an enlarged view of a coiled electrode on a portion of a catheter.

FIG. 4 shows a cross section of the catheter of FIG. 2.

FIG. 5 shows an apparatus for manufacturing coiled electrodes for the catheter of FIG. 2.

FIG. 6 a portion of the apparatus of FIG. 5.

FIG. 7 shows a cross section of the portion of the catheter of FIG. 3.

FIG. 8 shows a flow chart depicting the steps in manufacturing the catheter using the apparatus of FIG. 5.

FIG. 9 shows a flow chart depicting alternative steps in manufacturing the catheter using the apparatus of FIG. 5.

### DETAILED DESCRIPTION OF THE INVENTION

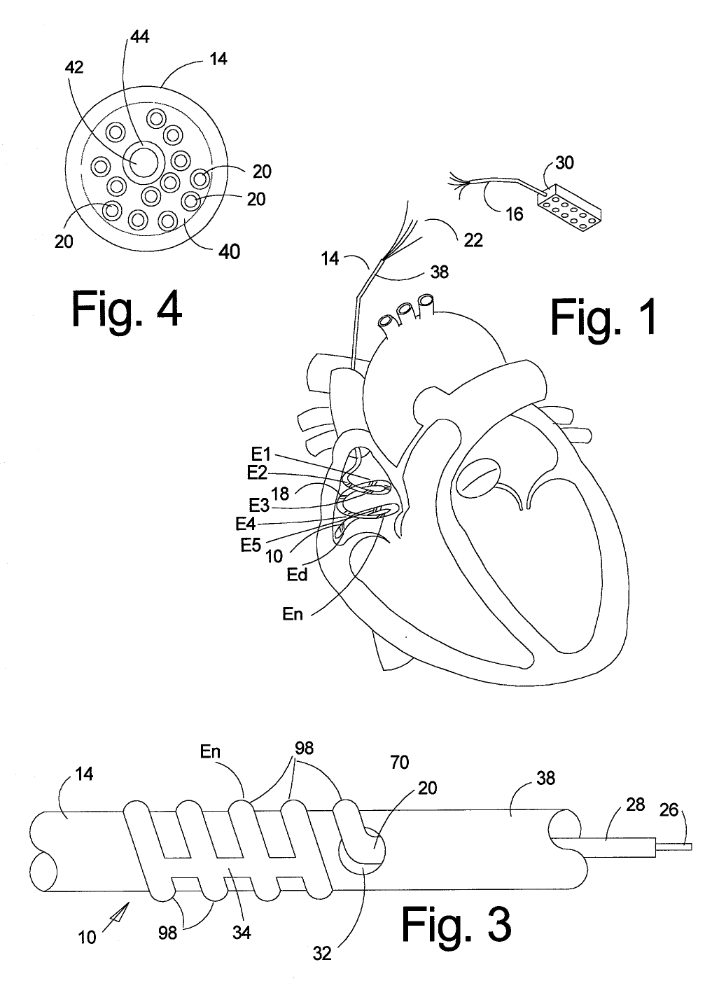

A multi-electrode lead or catheter 10 using coil electrodes made according to the apparatus and method of this invention is shown in FIG. 1. The catheter or lead may be implanted in the heart 12 or other body cavity of a patient. Implantation in the right atrium of the heart is illustrated, but implantation in any other chamber of the heart, blood vessel or body cavity is possible. The lead 10 includes an external biocompatible polymer tube 14 having a straight portion 16 and a shaped portion 18. The tube may be made of polyurethane or other similar materials that may be thermally shaped so that the shaped portion 18 retains any desired configuration. In FIG. 1 the shaped portion 18 is shown as having a spiral shape, but many other shapes may be selected as well. The spiral or coil shaped lead of FIG. 1 places electrodes around the entire atrial chamber of the heart. This embodiment allows complete sensing and stimulating control around the entire chamber.

It will be apparent that numerous shapes could be selected to address the clinical needs of a particular patient. Moreover, because the position of the electrodes in the heart or other body cavity is determined as much by physiology and implantation technique as by the characteristics of the lead, the effectiveness of the electrodes is best determined after implantation and is substantially independent from the location of a given electrode along the lead. For this reason, the availability of multiple redundant electrodes along a lead can be advantageous. The apparatus and method of this invention allow such electrodes to be manufactured efficiently.

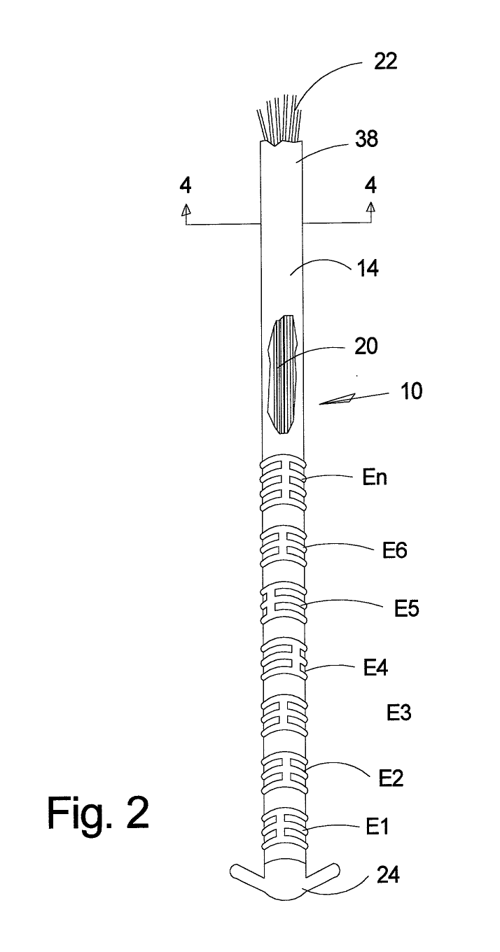

Attached to tube 14 of the lead 10 of any configuration, there are provided a plurality of electrodes E1, E2, E3, E4, E5, . . . En. The electrodes E1 . . . En are formed of coils of exposed wire or cable wound about the tube 14, as shown in FIG. 2 and FIG. 3. The catheter 10 includes a collection of wire leads 20 each having opposed terminal ends 22 and coiled electrodes E1 . . . En. The collection of wire leads 20 is encased in a tube 14. The tube 14 also has a tip member 24. The wire leads 20 are made from an electrical conductor 26. In the preferred embodiment, the electrical conductor is a MP35N, platinum, nitinol or stainless steel wire with a 0.003 inch (0.076 mm) diameter. The conductor may also be a cable such as a 1×7 cable made from seven 0.001 inch (0.025 mm) strands, with an overall diameter of 0.003 (0.076 mm). The wire lead has an insulated portion 28. The insulating material in the preferred embodiment has a thickness of 0.001 inch (0.024 mm) or less. Such insulating materials may include ETFE, PEA, polyimide, parylene, or polyurethane. Generally, the length of the wire lead must be coordinated with the length of the tube 14. The wire lead has a terminal end 22. The terminal end 22 of each wire is attached to a connector 30 for coupling electrically to a device for sensing or stimulating the heart or other body organ.

The wire 20 also has a coiled electrode En at the opposite end from the terminal end 22. The coiled electrode En is formed of several helical spirals or coils of the conductor 26. The diameter of each coil is sufficiently large to wrap around the exterior surface of the tube 14 of the catheter 10. In the preferred embodiment, the coiled electrode has between one and ten coils.

The wire 20 passes through a predrilled hole 32 in the tube 14. The predrilled hole 32 determines the exact location of the electrode. By changing the position and spacing of the hole, leads may be designed to cluster more electrodes along a selected segment of the lead. Preferably the coil En and wire 20 are formed of one continuous wire, as described below. The loops of the coil En are welded 34 or otherwise connected together to provide additional structural stability. Each electrode is connected to corresponding wires which extend through the length of tube 14 and which are shown exiting through end 38 for the sake of clarity. Wires 26 are insulated by insulators 28, so that they are not shorted to each other within the tube 14. Further details of the electrode En are disclosed in co-pending commonly assigned application Ser. No. 09/761,333, incorporated herein by reference.

The tube 14 can be formed with a longitudinal cavity 40, as shown in the cross sectional view of FIG. 4, taken along line 4-4 of FIG. 2. The cavity 40 holds the wires 20. The lead 10 can be straightened by inserting a substantially straight stylet 42 into a separate cavity 44. The stylet 42 is also flexible but is less flexible than the lead 10 so that as it is inserted into the cavity 44, it forces the tube 14 to straighten. The lead 10 is then inserted into the heart, blood vessel or other body cavity. After implantation of the lead 10, the stylet 42 is withdrawn and the lead 10 flexes back and takes a predetermined configuration, for example, the configuration shown in FIG. 1.

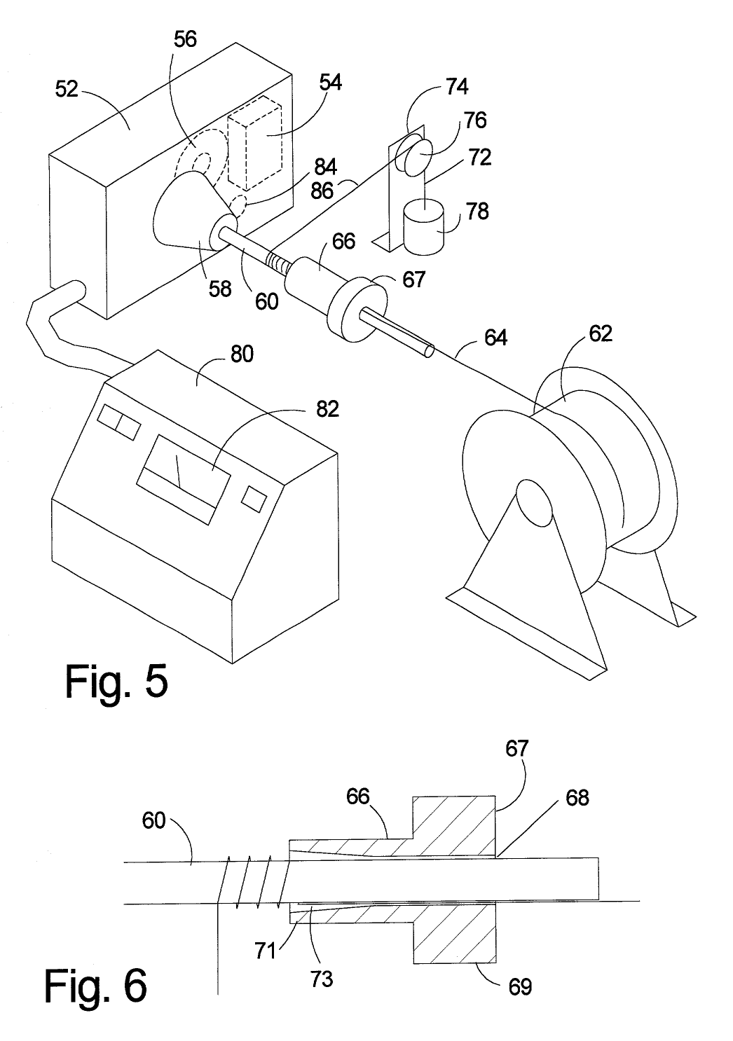

An apparatus 50 for forming coil electrodes having a well-defined surface area is illustrated in FIG. 5. The apparatus 50 comprises a drive mechanism 52 with an electric motor 54 coupled by a gear train 56 to a chuck 58. The chuck 58 supports a cylindrical mandrel 60. A spool 62 of wire is mounted to feed a wire 64 substantially parallel to a longitudinal axis of the mandrel 60. The mandrel 60 is rotated about the longitudinal axis to produce the coil. To produce a coiled electrode on a wire, the wire 64 is fed through an external sheath 66 and extended along the mandrel 60. The sheath has a through bore 68 large enough to receive both the mandrel 60 and the wire 64. Clearly, the diameter of the bore in the mandrel is chosen with reference to the desired size of the tube 14 of the catheter 10. The sheath 66 has a proximal end 67 that is usually mounted proximal to the spool 62 of wire. A flange 69 at the proximal end 67 of the sheath makes manipulation of the sheath easier. Preferably the resulting coil electrode, which forms near a distal end 71 of the sheath, will have an inside diameter the same size as the outside diameter of the tube. When the electrode and tube are assembled, a slight interference fit will then tend to hold the electrode in a desired place along the tube.

The diameter of the bore 68 of the external sheath 66 will be slightly larger than the diameter of the mandrel 60 to accept the wire 64. The tightness of the fit between the sheath, wire and mandrel will affect the sharpness of a bend 70 between the coil electrode and the wire lead 20, that is, the straight portion of the wire 64 that will be inserted into the tube 14. This bend 70 can best be seen in FIG. 3. A portion 73 of the bore may be enlarged to allow a larger bend 70 to form as the mandrel is rotated. With the wire 64 extending through the bore 68 of the sheath and along the mandrel, the sheath 66 is pushed onto the mandrel, capturing the wire 64 between the mandrel and the sheath. The wire 64 is then extended generally perpendicular to the axis of the mandrel, that is, between plus or minus 30 degrees from true perpendicular, more preferably between plus or minus 15 degrees from true perpendicular. An end 72 of the wire 64 is attached to a tensioning device 74. The tensioning device may comprise, for example, a pulley 76 and suspended weight 78 or ball slide. Other tensioning devices, such as a spring or pneumatics, can also be used. The amount of tension is set to plastically deform the wire 64. This tension is therefore dependent on such factors as the composition and diameter of the wire and the diameter of the mandrel.

A controller 80 in electrical communication with the drive mechanism 52 controls the action of the apparatus 50. Preferably, the controller comprises a programmable counter 82 such that a specified number of turns or partial turns may be specified. A sensor 84 detects the rotation of the electric motor or of the chuck or mandrel, so that the number of turns can be counted at the controller 80. Alternatively, of course, displacement of the wire 64 or of the tensioning device, particularly movement of the weight 78, could be used to control the operation of the apparatus.

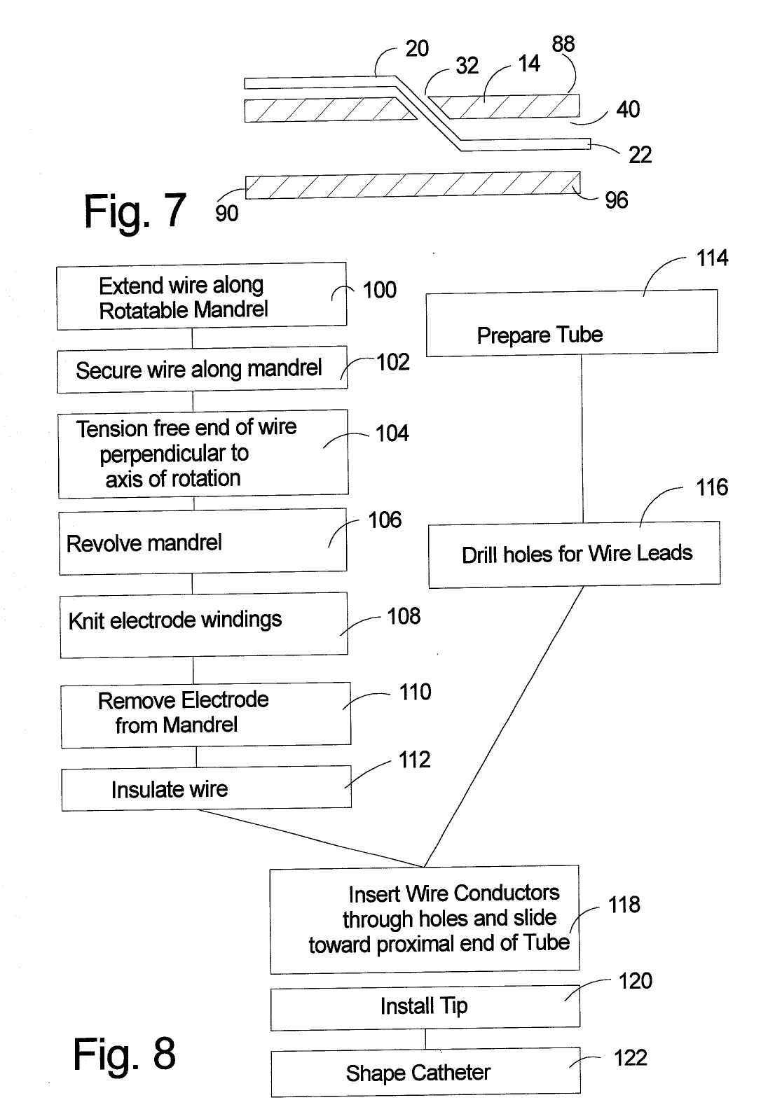

Responsive to the controller 80, the electric motor 54 turns the chuck 58 and mandrel 60. Preferably the mandrel 60 turns at slow speed, for example 1 revolution per second, for better control of the formation of the coil electrode. The gear train 56 reduces the speed to the electric motor 54 to the speed desired for the chuck. When the mandrel has been turned the selected amount, and a coil electrode formed in the wire 64, a free end 86 of the wire 64 may be trimmed away. The sheath and wire can be removed from the mandrel. A desired length wire lead 20 can be extracted from the spool 62 and the coil electrode and wire lead can be severed from the wire. The apparatus is then ready to make another electrode and wire lead combination. The wire lead 20 slides into an insulator 28, such as a polyimide tube or can be coated with a deposition process such as parylene. FIG. 7 depicts the installation of a wire lead 20 into a tube 14 with holes 32. The terminal end 22 of the wire lead 20 is inserted from the exterior surface 88 through the hole 32 into the central cavity 40 away from the distal end 90 of the tube.

FIG. 3 shows a coiled electrode En extending out through a hole 32 with the insulated portion 28 of the wire lead within the tube 14. In the completed assembly of the catheter 10, the coils of the coiled electrode En are wrapped around the exterior surface 88 of the tube 14. The coils 98 of the coiled electrode En are knit together or otherwise connected by a cross-bar 34 to keep the coils from separating from the tube and to keep the coils wrapped tightly together. In one embodiment, the coils are knit to each other or fused with a heat source such as an eximer laser. Thus, the cross-bar 34 between the coils 98 is formed by welds or a fusing of the coils 54. In an alternative embodiment, the coils 54 are joined with an adhesive.

The steps in the assembly of the catheter are summarized in FIG. 8. The assembly process starts with extending a wire or cable along a rotatable mandrel, step 100. The wire is secured along the mandrel, step 102. A free end of the wire or cable is placed under tension at an angle generally perpendicular to the axis of rotation of the mandrel, step 104. The tension is sufficient to cause plastic deformation of the wire. The mandrel is revolved, step 106, forming a coil electrode around the mandrel. Because the rotations can be precisely selected and because the size of the wire and the size of the mandrel are known, the size and surface area of the electrode can be determined. Consequently, different sizes of electrodes may be specified for different functions on the same or different catheters. Re-tooling for production of different size electrodes is unnecessary. The electrode windings or loops may then be knit together, step 108. This may comprise welding or adhesive or other processes. The wire and electrode are then removed from the mandrel, step 110. After the electrode and wire are removed from the mandrel, the wire is insulated, step 112. This may comprise inserting the wire into an insulating polyimide tube, or coating with an insulating material.

At the same time, a biocompatible, flexible tube is prepared, step 114. In a drilling step 116, angled holes for each wire lead are drilled into the tube. In an insertion step 118, each wire lead is entrained into the tube by inserting one terminal end 22 of a wire lead into each hole 32 and forcing the wire lead 20 down the length of the tube 14 until only the coiled electrode En extends from the hole 32. After each wire lead 20 is separately inserted, the tip member is installed, step 120, and then the electrode catheter is given its shape, step 122, by heating the catheter in a jig.

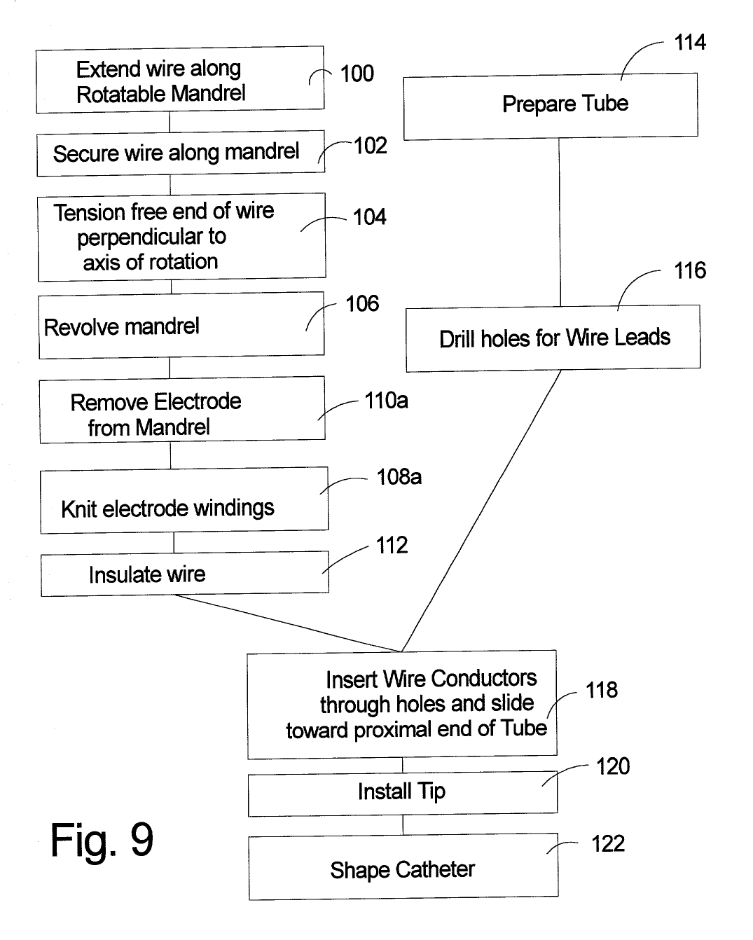

An alternative procedure is illustrated in FIG. 9. In this procedure, the steps 100 through 106 and 112 through 122 are as described above in connection with FIG. 8. Steps 108 and 110, however, have been reversed and are labeled 108a and 110a. In the process of FIG. 8, the electrode windings are knit together at step 108 while the coil electrode is still on the mandrel. Thereafter, the electrode and wire are removed from the mandrel, step 110. In the process of FIG. 9, the electrode and wire are first removed from the mandrel, step 110a. With the electrode free from the mandrel, the windings or loops can be joined as described above by welding, adhesive or other process.

The exemplary apparatus and method provide for production of coiled electrodes whose surface area can be specified and varied without extensive re-tooling or re-design. Electrodes on implantable catheters can be optimized for function and multiple electrodes can be provided at low cost. The electrodes and wires communicating to devices are formed of a single integral wire or cable, eliminating stress points at the junction between electrodes and communicating wires.

Those skilled in the art will recognize that changes may be made to the described embodiments of the invention without departing from the teachings thereof. The foregoing description is intended to be illustrative and not restrictive, and the scope of the invention is intended to be set forth in the following claims.

What is claimed is:

1. An apparatus for manufacturing implantable electrodes, said electrodes comprising a coil electrode and an integral conductor, said apparatus comprising
a mandrel having an axis of rotation,
a conductor source providing a conductor extending generally parallel to said axis of rotation,
a tensioning device mounted generally perpendicular to said axis of rotation of said mandrel releasably coupled to a free end of said conductor, and
a holding apparatus on said mandrel, said holding apparatus holding said conductor from said conductor source against said mandrel.

2. The apparatus of claim 1 wherein the holding apparatus comprises a sheath.

3. The method of claim 2 wherein said sheath comprises a through bore and at least a portion of said bore adjacent said free end of said conductor is sized to control a bend between said coil electrode and said straight conductor

4. The apparatus of claim 2 wherein the sheath comprises a tube having a distal end and a proximal end adjacent said conductor source and a flange adjacent said proximal end.

5. The apparatus of claim 1 further comprising a motor coupled to said mandrel, said motor turning said mandrel about said axis of rotation.

6. The apparatus of claim 5 wherein a chuck couples said motor to said mandrel.

7. The apparatus of claim 6 further comprising reduction gears coupling said motor and said chuck.

8. The apparatus of claim 7 further comprising a sensor counting revolutions and adapted to stop said motor when a pre-selected number of revolutions have been made.

9. The apparatus of claim 8 wherein the sensor counts revolutions of the motor.

10. The apparatus of claim 1 wherein the tensioning device comprises a suspended weight.

11. The apparatus of claim 10 wherein the tensioning device can be loaded with different amounts of mass.

12. The apparatus of claim 1 wherein said conductor source comprises a roll of wire.

13. The apparatus of claim 1 wherein said conductor comprises a wire.

14. The apparatus of claim 1 wherein said conductor comprises a cable.

15. The apparatus of claim 1 wherein said free end of said conductor forms an angle between said axis of rotation of said mandrel of between 60 degrees and 120 degrees.

16. The apparatus of claim 15 wherein said angle is between 75 degrees and 105 degrees.

17. The apparatus of claim 16 wherein said angle is 90 degrees.

18. A method for manufacturing implantable electrodes, said electrodes comprising
a coil electrode and an integral conductor, said method comprising
providing a mandrel having an axis of rotation,
extending a conductor generally parallel to said axis of rotation from a conductor source,
holding said conductor against said mandrel,
extending a free end of said conductor generally perpendicular to said axis of rotation from said mandrel to a tensioning device mounted generally perpendicular to said axis of rotation of said mandrel,
applying a tensioning force to said free end of said conductor and
rotating said mandrel to wind said free end of said conductor around said mandrel.

19. The method of claim 18 wherein holding said conductor comprises placing a sheath around said mandrel, said conductor lying between said sheath and said mandrel.

20. The method of claim 19 wherein said sheath comprises a through bore and said method further comprises sizing at least a portion of said bore adjacent said free end of said conductor to control a bend between said coil electrode and said straight conductor.

21. The method of claim 19 wherein the sheath comprises a tube having a distal end and a proximal end adjacent said conductor source and a flange adjacent said proximal end.

22. The method of claim 18 wherein rotating said mandrel further comprises driving said mandrel with a motor coupled to said mandrel, said motor turning said mandrel about said axis of rotation.

23. The method of claim 22 further comprising counting revolutions and stopping said motor when a pre-selected number of revolutions have been made.

24. The method of claim 23 wherein the revolutions of the motor are counted.

25. The method of claim 18 wherein the tensioning force may be selected.

26. The apparatus of claim 25 wherein the tensioning force is selected by loading the tensioning device with different amounts of mass.

27. The method of claim 18 wherein said conductor comprises a wire.

28. The method of claim 18 wherein said conductor comprises a cable.

29. The method of claim 18 wherein said free end of said conductor forms an angle between said axis of rotation of said mandrel of between 60 degrees and 120 degrees.

30. The method of claim 29 wherein said angle is between 75 degrees and 105 degrees.

31. The method of claim 30 wherein said angle is 90 degrees.

32. A method for manufacturing implantable lead comprising
forming a coil electrode and an integral conductor by
providing a mandrel having an axis of rotation,
extending a conductor generally parallel to said axis of rotation from a conductor source,
holding said conductor against said mandrel,
extending a free end of said conductor generally perpendicular to said axis of rotation from said mandrel to a tensioning device mounted generally perpendicular to said axis of rotation of said mandrel,
applying a tensioning force to said free end of said conductor, and
rotating said mandrel to wind said free end of said conductor around said mandrel, thereby forming a coil electrode,
cutting said conductor to leave a straight conductor extending from said coil electrode,
insulating said straight conductor,
inserting said straight conductor through a hole in a wall of an elastomeric tube, said hole being near a distal end of said elastomeric tube,
drawing said straight conductor through said tube until said coil electrode is substantially adjacent said hole, and
attaching a proximal end of said straight conductor to an electrical connector.

33. The method of claim 32 wherein holding said conductor comprises placing a sheath around said mandrel, said conductor being between said sheath and said mandrel.

34. The method of claim 33 wherein said sheath comprises a through bore and said method further comprises sizing at least a portion of said bore adjacent said free end of said conductor to control a bend between said coil electrode and said straight conductor.

35. The method of claim 33 wherein the sheath comprises a tube having a distal end and a proximal end adjacent said conductor source and a flange adjacent said proximal end.

36. The method of claim 32 wherein rotating said mandrel further comprises driving said mandrel with a motor coupled to said mandrel, said motor turning said mandrel about said axis of rotation.

37. The method of claim 36 further comprising counting revolutions and stopping said motor when a pre-selected number of revolutions have been made.

38. The method of claim 37 wherein the revolutions of the motor are counted.

39. The method of claim 32 wherein the tensioning force may be selected.

40. The method of claim 39 wherein the tensioning force is selected by loading the tensioning device with different amounts of mass.

41. The method of claim 32 wherein said conductor is a wire.

42. The method of claim 32 wherein said conductor is a cable.

43. The method of claim 32 wherein said free end of said conductor forms an angle between said axis of rotation of said mandrel of between 60 degrees and 120 degrees.

44. The method of claim 43 wherein said angle is between 75 degrees and 105 degrees.

45. The method of claim 44 wherein said angle is 90 degrees.
